(19) United States
(12) Patent Application Publication
(10) Pub. No.: US 2013/0159699 A1
(43) Pub. Date: Jun. 20, 2013

(54) Password Recovery Service

(71) Applicant: Juha TORKKEL, Vantaa (FI)

(72) Inventor: Juha TORKKEL, Vantaa (FI)

(73) Assignee: F-Secure Corporation

(21) Appl. No.: 13/328,002

(22) Filed: Dec. 16, 2011

(51) Int. Cl. H04L 9/00; H04L 9/32

(52) U.S. Cl. 713/155; 380/277; 380/286; 726/3

(57) ABSTRACT

According to aspects of the present invention there are provided methods and apparatus for enabling a user to secure and back-up an encryption key for use by a client device in encrypting and decrypting data, enabling the user to change a user secret previously used to secure the encryption key, and enabling a server to update the user secret with a new user secret for securing a previous user encrypted key. The new user encrypted key can be used by the client device for encrypting and decrypting data, including data encrypted and decrypted using the previous user encrypted key. The methods for enabling a user to secure and back-up the encryption key and enabling a user to change the user secret may be performed on the client device or a trusted third party or service provider device. The method for updating the user secret with a new user secret may be performed on a service operator server or system.

### TECHNICAL FIELD

The present invention relates to methods and apparatus for enabling a user to secure an encryption key with a user secret, which is used to provide a device with access to the encryption key for encrypting and decrypting data. In particular, the present invention relates to methods and apparatus for enabling the user to secure the encryption key using the user secret, secure a back-up of the encryption key using a service operator's secret, and subsequently change the user secret using the back-up encryption key.

### BACKGROUND

Passwords and various user secrets are essential for everyday life including computing, networked computing, and cloud-based services. Secure on-line data storage services may include back-end mass storage in communication over a communication network with networked application software executing on a client device.

Secure on-line storage applications read and write data over the communication network to the back-end data storage. All data can be encrypted and decrypted by the application using an encryption key before and after each write and read. The application may also use persistent local storage on the client device for locally encrypting and decrypting data. However, should an unauthorised user gain access to the encryption key, then all the encrypted data may be accessed by the unauthorised user. Securing the encryption key with a user secret or a password can overcome such unauthorised access.

User secrets such as passwords are essential for everyday life including computing, networked computing, and cloud-based services. However, people currently have so many passwords that it is easy to forget individual passwords for subscribed computing services or resources. With a secure encryption service this raises another potential problem when users forget their user secrets or passwords. Once forgotten, an encryption key encrypted with a password may not be recoverable meaning all the encrypted data becomes inaccessible. Changing or resetting a user's secret or password is essential for continued use of the computing service.

A user may allow a trusted third party such as the system administration team of a service provider to have access to the user secret or password and/or the encryption key allowing recovery. However, this provides another means by which an unauthorised user or hacker could gain access to the user's secret and/or encryption key. The user of the computing service has to overcome the uncertainty in trusting the third parties service provider's systems are secure. This is currently a concern that many users need addressed for cloud-based secure on-line data storage services.

Should a third party hold back-ups of the user secret and/or encryption key, it then becomes almost impossible to identify who actually has access to a user's secured stored data.

GB2367933 describes a method for paper based backup of passwords in which a password or encryption key is rendered and can be handwritten to paper in a shorthand form for storage. It is the user's responsibility to keep the piece of paper and hence access to the password or encryption key safe. However, if someone steals or copies this piece of paper the encryption key will have leaked and the data secured against the encryption key can be accessed by a third party or unauthorised user.

There is a need to further protect data that has been protected by a master secret (e.g. encryption key encrypted by a user secret) in case of theft or copying. Further, when a user forgets the master secret or cannot access the master secret (e.g. forgets the user secret or an encryption key encrypted by a user secret is corrupted) then there is a need to securely reset the master secret, but at the same time allowing the user to keep accessing data protected by the original master secret and also keeping control of who has access to the new password or user secret.

### SUMMARY

It is an object of the present invention to provide a method of securing an encryption key using a user secret, generating a back-up encryption key, and updating the secured encryption key to minimise the number of entities that can gain access to a user's stored data secured by the encryption key.

According to a first aspect of the invention there is provided a method of enabling a user to secure and back-up an encryption key for use by a client device in encrypting and decrypting data, the method including receiving a user secret from the user, encrypting the encryption key with the user secret to produce a user encrypted key and storing the user encrypted key on the client device, encrypting the encryption key with a service operator secret to produce a back-up encrypted key and storing the back-up encrypted key, and removing the encryption key such that the encryption key can only be accessed by the client device via the user encrypted key and the user secret.

Optionally, when the client device performs encryption or decryption of data, the method further provides the steps of prompting the user for the user secret, decrypting the user encrypted key with the user secret to produce the encryption key, encrypting or decrypting data using the produced encryption key, and removing the produced encryption key after use.

Optionally, receiving the user secret further includes inputting the user secret by the user. Inputting the user secret may further include inputting a plaintext user secret, and encrypting the plaintext user secret to produce the user secret. As another option, storing the back-up encrypted key further includes storing the back-up encrypted key in a machine readable format. Alternatively or additionally, storing the back-up encrypted key may further include storing the back-up encrypted key externally to the client device in a machine readable format.

As a further option, the client device is unable to decrypt the back-up encrypted key using the service operator secret. The service operator secret may be a public encryption key and the service operator has a corresponding private encryption key for use in decrypting the back-up encrypted key. In addition, the method further comprises the step of synchronising the user encrypted key with a further client device for encrypting and decrypting data using the further client device.

According to a second aspect of the invention there is provided a method for enabling a user to change a user secret previously used to secure an encryption key for use by a client device in encrypting and decrypting data, where the user has access to a back-up encrypted key comprising the encryption key encrypted by a service operator secret, the method including receiving a new user secret and the back-up encrypted key, encrypting the new user secret and the back-up encryption key with the service operator secret to produce encrypted back-up information, transmitting the encrypted back-up information to the service operator for securely encrypting the encryption key using the new user secret to produce a new user encrypted key, where the new user encrypted key is used for updating the previous user encrypted key stored on the client device.

As an option, the method further includes receiving the new user encrypted key for updating the previous user encrypted key stored on the client device. In addition, the step of receiving the new user encrypted key may further include retrieving from the service operator the new user encrypted key for use in updating the previous user encrypted key stored on the client device.

Optionally, the step of receiving the new user secret on the client device or third party device includes inputting the new user secret by the user. The step of inputting the new user secret may include the steps of inputting a plaintext new user secret, and encrypting the plaintext new user secret to produce the new user secret.

Optionally, the step of receiving includes the client device performing the step of receiving the back-up encrypted key and the new user secret, the step of encrypting includes the client device encrypting the new user secret and the back-up encryption key with the service operator secret to produce encrypted back-up information, the step of transmitting includes the client device transmitting the encrypted back-up information to the service operator. As an alternative option, a third party device or device external to the client device performs the steps of receiving the back-up encrypted key and a new user secret, encrypting the new user secret and the back-up encryption key with the service operator secret to produce encrypted back-up information, and transmitting the encrypted back-up information to the service operator. For added security, the third party device may be a trusted third party device or a service provider device.

As an option, the method includes authenticating or positively authenticating the identity of the user prior to transmitting the encrypted back-up information to the service operator. The method may further include verifying the identity of the user prior to transmitting the encrypted back-up information to the service operator, and only transmitting the encrypted back-up information to the service operator on a positive decision in relation to the identity of the user. Alternatively, a third party device may perform the steps of authenticating (or positively authenticating) the user or verifying the identity of the user. For added security, the third party device may be a trusted third party device or a service provider device.

As another option, the step of transmitting the encrypted back-up information to the service operator further comprises transmitting the encrypted back-up information to the service operator via a third party. Additionally, the method includes transmitting authentication information from the client device for use by the third party in positively authenticating the user prior to the third party transmitting the back-up encrypted information to the service operator. For added security, the third party may be a trusted third party or a service provider.

According to a third aspect of the invention there is provided a method for enabling a server to update a previous user encrypted key secured by encrypting an encryption key with a user secret, the encryption key for use by a user's client device to encrypt and decrypt data, and the user having access to a back-up encrypted key comprising the encryption key encrypted by a service operator secret, the method including receiving encrypted back-up information from the user at the server, the encrypted back-up information comprising a new user secret and the back-up encrypted key encrypted with the service operator secret, decrypting the encrypted back-up information using a corresponding service operator secret to produce the encryption key and the new secret, encrypting the encryption key with the new secret producing a new user encrypted key, removing the received back-up encrypted information, the decrypted new secret and the decrypted encryption key such that the server only has access to the new user encrypted key, storing the new user encrypted key for use by the user in updating the previous user encrypted key on the client device.

As an option, there is provided the step of synchronising the client device with the new user encrypted key on the server. Alternatively the client device may retrieve the new user encrypted key from the server, or the server may transmit the new user encrypted key to the client device or a third party device for later retrieval by the client device or user. After synchronising, or transmitting the new user encrypted key, the server may remove the new user encrypted key. Optionally, the server may perform an authentication procedure to authenticate the identity of the user prior to receiving the encrypted back-up information. In addition, the server may perform another authentication procedure to authenticate the identity of the user prior to transmitting or synchronising the new user encrypted key.

According to another aspect of the invention there is provided an apparatus for use in enabling a user to secure and back-up an encryption key for use by the client device in encrypting and decrypting data, the apparatus comprising a receiver, a transmitter, a memory unit, and a processor, the processor being connected to the receiver, to the transmitter, and to the memory unit. The processor is configured to receive the user secret, encrypt the encryption key with the user secret to produce a user encrypted key and stores the user encrypted key on the memory unit, encrypt the encryption key with a service operator secret to produce a back-up encrypted key and stores the back-up encrypted key externally of the client device, and remove the encryption key such that the encryption key can only be accessed by the client device using the user secret.

Optionally, the processor and transmitter are further configured to synchronise the new user encrypted key with a further client device for encrypting and decrypting data using the further client device. As an option, the client device may include the apparatus or a third party device may include the apparatus.

According to a further aspect of the invention there is provided an apparatus for use in enabling a user to change a user secret previously used to secure an encryption key for use by a client device in encrypting and decrypting data, wherein the user has access to a back-up encrypted key comprising the encryption key encrypted by a service operator secret, wherein the back-up encrypted key is stored externally to the client device, the apparatus comprising a receiver, a transmitter, a memory unit, and a processor, the processor being connected to the receiver, to the transmitter, and to the memory unit. The processor is configured for receiving a new user secret and/or the back-up encrypted key. The processor is configured to encrypt the new user secret and the back-up encryption key with the service operator secret to produce encrypted back-up information. The transmitter is configured to transmit the encrypted back-up information to the service operator for securely encrypting the encryption key using the new user secret to produce a new user encrypted key for use in updating the previous user encrypted key stored on the client device.

As an option, the processor and transmitter are further configured to synchronise the new user encrypted key with the client device for encrypting and decrypting data. As another option, the client device may include the apparatus or a third party device may include the apparatus.

According to another aspect of the invention there is provided an apparatus or server for use in enabling a service operator system to update a previous user encrypted key secured by encrypting an encryption key with a user secret, the encryption key for use by a user's client device to encrypt and decrypt data, where the user has access to a back-up encrypted key comprising the encryption key encrypted by a service operator secret and the server comprising a receiver, a transmitter, a memory unit, and a processor, the processor being connected to the receiver, to the transmitter, and to the memory unit. The receiver receives encrypted back-up information from the user, the encrypted back-up information comprising a new user secret and the back-up encrypted key encrypted with the service operator secret. The processor is configured to decrypt the encrypted back-up information using a corresponding service operator secret producing the encryption key and the new user secret, encrypt the encryption key with the new secret producing a new user encrypted key, remove the received back-up encrypted information, the decrypted new secret and the decrypted encryption key such that the service operator only has access to the new user encrypted key, and store the new user encrypted key for use by the user in updating the previous user encrypted key on the computing device.

Optionally, the transmitter is configured to send the new user encrypted key to the client device or a third party device. As an option, there may be provided a system including a plurality of servers, each configured to perform at least one of the steps of the methods and or perform at least one of the functions of the server apparatus as described.

The user secret may include at least one form of secret information from the group of a user password, a user passcode, biometric data, a secret gesture, a biometric fingerprint, facial recognition data, voice recognition data, information or data of the user to secure the encryption key, and information or data selected by the user to secure the encryption key. The user secret may include at least one form of secret information that has been encrypted.

According to further aspects of the invention there is provided a computer readable medium including computer program instructions stored thereon, which when executed on one or more processors of a client device, a device or a server or a plurality of servers, performs one or more of the methods as described.

### BRIEF DESCRIPTION OF THE DRAWINGS

FIG. 1 illustrates schematically a system according to embodiments of the present invention;

FIG. 2a illustrates schematically a flow diagram according to embodiments of the present invention;

FIG. 2b illustrates schematically another flow diagram according to embodiments of the present invention;

FIG. 2c illustrates schematically a further flow diagram according to embodiments of the present invention.

### DETAILED DESCRIPTION

In order to at least partially overcome the problems described above, it is proposed herein to improve a user's control over securing encryption keys on a computing device or client device, generating back-up encryption keys, and changing user secrets used to secure the encryption keys.

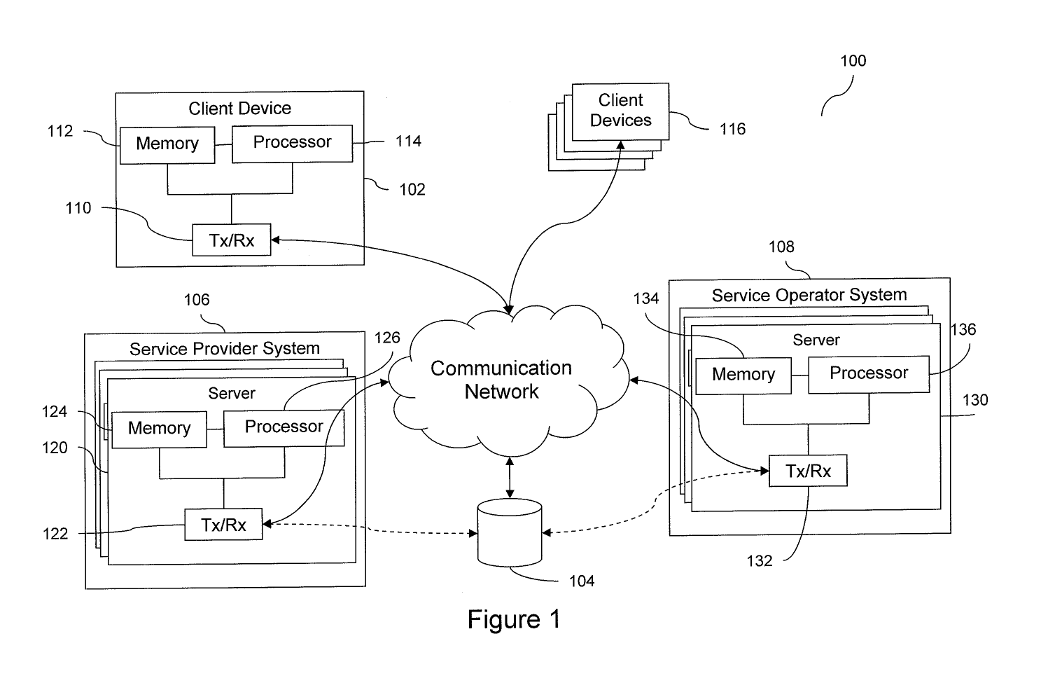

FIG. 1 illustrates a system 100 for secure data storage, the system 100 includes a client device 102 operated by a user that has access to data storage 104. Client device 102 can be in communication over a communication network with a service provider system 106, which is an entity that provides the client device 102 with services such as an application for providing secure access services to data storage 104. The service provider system 106 may be a third party or a trusted third party entity or system such that it can facilitate interactions between two parties both trusting the third party. The service provider system 106 is also in communication over the communication network with a service operator system 108, which is an entity that may provide a security service for use with the applications provided by the service provider system 106, for example, a secure service for recovery of secured encryption keys, user secrets or passwords used in storing data on data storage 104. Such secure services may include changing or resetting the user's access to the data storage 104.

The user secret may comprise or represent any information known, input, or selected by a user or any information of the user that can be used in securing access to sensitive information. For example, a user secret may include a user password such as a secret word or string of characters or secret numerical information such as a passcode, biometric data related to the user or known to the user, a secret gesture, a biometric fingerprint, facial recognition data, eye or iris data, voice recognition data, or any other information of the user or any other information selected by the user to secure access to sensitive information, or any combination of these. The user secret may further include a cryptographically derived interpretation from a user secret input by a user, for example a user secret input by a user could be passed to a cryptographic hash function (e.g. secure hash algorithm (SHA) such as SHA256 or Hash-based Message Authentication Code HMAC) producing a single hash value or message digest, in which the hash value or message digest is used in place of the input user secret. That is, the user secret may further comprise at least one form of user secret information or a user secret that has been encrypted.

For example, the user secret may include at least one form of secret information from the group of, a user password such as a secret word or string of characters, or secret numerical information such as a passcode, biometric data related to the user or known to the user, a secret gesture, a biometric fingerprint, facial recognition data, eye or iris data, voice recognition data, or any other information of the user or any other information selected by the user to secure access to sensitive information, or any combination of these. The user secret may further be encrypted and the encrypted user secret used in place of the user secret input by the user.

The client device 102 is for use in enabling a user to secure and back-up an encryption key for use by the client device 104 in encrypting and decrypting data. The client device 102 includes a transmitter/receiver 110, a memory unit 112, an input unit 113, and processing logic or processor 114. The processor 114 is connected to the transmitter/receiver 110, to the memory unit or memory 112. The memory 112 can be for use in storing data and applications, and the processor 114 may execute the applications, and among other things, applications or processes for encrypting and decrypting data for storage on memory unit 112 or data storage 104 using the communication network.

The client device may comprise or represent any electronic device used for wireless or wired communications. Examples of client devices that may be used in certain embodiments or examples of the invention are electronic devices such as devices supporting “plug-ins” or “apps” or have open or proprietary Software Development Kits (SDKs), television set top boxes, gaming consoles, Network Attached Storage (NAS) devices, Operator Customer Premise Equipment (CPE), wired and/or wireless devices that can connect to a communication network, electronic devices such as personal computers, terminals, or portable devices such as mobile, handheld or portable devices, portable media players, mobile telephones, smart phones, handheld gaming consoles, portable computing devices such as lap tops, tablet devices, net-books, computers, personal digital assistants, or other devices that can connect wirelessly to a communication network.

An input unit may be used to receive data input into the client device 102 such as the user secret. As such, the input unit may be connected to any form of input mechanism for inputting a user secret, which may include, but is not limited to, a keyboard or keypad, a camera, biometric scanner, scanning hardware, optical scanner, secret gesture detector, touch pad or touch screen, barcode scanner, a receiver. The input unit may simply be a receiver that receives the user secret from any input mechanism or device. Alternatively, the user secret may be received by the receiver 110 from another device.

The processor 114 is configured to receive the user secret from the user, and encrypt the encryption key with a user secret to produce a user encrypted key and stores the user encrypted key on the memory unit 112. The processor 114 may generate the encryption key when an application relating to secure data storage is first run on the client device 102. Processor 114 may also generate the user secret or cryptographically derive the user secret from the user inputting a plaintext user secret, into an input mechanism, and on receiving the plaintext user secret the processor 114 may encrypt the plaintext user secret to provide the user secret. For example, the plaintext user secret may be processed by a cryptographic hash function (e.g. SHA256 or HMAC) to provide a single hash value or message digest that is used as the user secret.

The processor 114 is also configured to encrypt the encryption key with a service operator secret to produce a back-up encrypted key for storage on the client device 102. The processor 114 may be configured to store the back-up encrypted key externally to the client device 102 in a machine readable format. This provides the advantage that the back-up encrypted key can be physically secured to prevent theft or accidental loss of the back-up encrypted key should the client device 102 be stolen or become damaged.

The service operator secret may be provided to the client device 102 or an application executed on the client device 102 by the service provider system 106, a trusted third party or directly from the servicer operator system 108. For added security, the client device 102 may be configured to be unable to decrypt the back-up encrypted key using the service operator secret. Alternatively, the encryption system used to encrypt the back-up encryption key with the service operator secret may be configured to require another key unknown to the client device 102 or the user of the client device 102 for decrypting the back-up encrypted key. For example, the service operator secret may be a public encryption key and the service operator has a corresponding private encryption key.

After generating the user encrypted key and the back-up encrypted key, the processor 114 removes the encryption key from memory 112 such that the encryption key can only be accessed by the client device 102 or an application on the client device 102 using the user secret. For added security, the processor 114 irretrievably removes or securely removes the encryption key from the memory 114 or client device 102. The processor 114 may also remove the user secret used to generate the user encrypted key from memory 112 and/or the client device 102. Again, the processor 114 may be configured to irretrievably remove the user secret. The client device 102 may further be arranged to synchronise the new user encrypted key with one or more further client devices 116 for use by the further client device 116 or applications thereon in encrypting and decrypting data using the same encryption key.

As an example of using the user encrypted key, it is assumed the client device 102 no longer has access to the encryption key, i.e. it has been irretrievably removed from the client device 102. The client device 102 may also not have access to the user secret. An application on the client device 102 may use the user encrypted key for an encrypting and/or decrypting session by prompting the user for the user secret, or a plaintext user secret from which the processor 114 generates the user secret. The application on the client device 102 may then use the user secret to decrypt the user encrypted key to produce the encryption key and then uses the produced encryption key during the encrypting and/or decrypting session. Should the incorrect user secret be entered, the processor 114 may be configured to generate an error message or exception indicating to the application that the encryption key could not be decrypted and that the user secret is incorrect.

The client device 102 or the application on the client device 102 may be arranged to configure the processor 114 and memory 112 to remove the user secret after decrypting the user encrypted key, and to remove the produced encryption key after the encrypting and/or decrypting session. This will ensure the encryption key can be accessed or used via the user secret. In particular, the client device 102 may be configured to securely remove the user secret and the encryption key.

The client device 102 may be further configured for use in enabling the user to change the user secret previously used to secure the encryption key for use by the client device 102 in encrypting and decrypting data. It is assumed that the user has access to the back-up encrypted key comprising the encryption key encrypted by the service operator secret. The processor 114 is further configured to receive a new user secret from the user and to receive the back-up encrypted key, the processor 114 is further configured to encrypt the new user secret and the back-up encryption key with the service operator secret to produce encrypted back-up information. The service operator secret may be stored in the memory 112 of the client device 102. The transmitter/receiver 110 is further configured to transmit the encrypted back-up information to the service operator system 108 for securely encrypting the encryption key using the new user secret to produce a new user encrypted key.

Once the new user encrypted key is ready then the new user encrypted key may be transmitted to the client device 102. The transmission may be directly to the client device 102 or via a trusted third party. Communicating the new user encrypted key to the client device 102 may be performed using “push” or “pull” communications. In push communications, the publisher or the service operator initiates the transaction for transmitting the new user encrypted key to the client device 102. For example, this may be over the Internet where the request for a given transaction is initiated by the service operator or a central server or portal that may store the new user encrypted key. As another example, the transmitter/receiver 110 and processor 114 may be further configured to receive a notification from the service operator system 108, the notification for notifying the client device that the new user encrypted key may be retrieved from the service operator system 108 for use in updating the previous user encrypted key stored on the client device 102. Alternatively, the transmitter/receiver 110 and processor 114 of the client device 102 may be further configured to automatically detect that the new user encrypted key is ready for retrieval from the service operator system 108. In any event, the new user encrypted key is transmitted from the service operator system 108 towards the client device 102 (either directly to the client device 102 over a communications network or indirectly via a trusted third party).

In addition the service provider system 106 includes one or more servers 120, which may be used for providing secure data storage services to the client device 102 using data storage 104, and which can also enable the user of client device 102 to change the user secret previously used to secure the encryption key for use by the client device 102 in encrypting and decrypting data. That is the service provider system 106 may act as a trusted third party entity to allow the client device 102 to change the user secret and update the user encrypted key. If the service provider system 106 acts as a trusted third party who authenticates and authorises the change of the user secret and hence the change of the user encrypted key, then the service provider system 106 may perform a key exchange with the service operator system 108 and produce a digital signature that the service operator system 108 may use to verify the authenticity of the change of the user secret. This can be used to track who authorised the change of user secret.

The user has access to the back-up encrypted key comprising the encryption key encrypted by the service operator secret. The server 120 may include a transmitter/receiver 122, a memory 124, and a processor 126, the processor 126 being connected to the transmitter/receiver 122 and to the memory 124. The memory 124 can be for use in storing data and applications, and the processor 126 may execute the applications, and among other things, applications or processes for enabling the user to change the user secret previously used to secure the encryption key for use by the client device 102 in encrypting and decrypting data for storage on data storage 104 using the communication network.

The processor 124 is configured to receive a new user secret from the user or client device 102, and to receive the back-up encryption key from the user, and the service operator secret from either the service operator 108 or from the user or client device 102. The processor 124 is further configured to encrypt the new user secret and the back-up encryption key with the service operator secret to produce encrypted back-up information. The transmitter/receiver 122 are configured to transmit the encrypted back-up information to the service operator system 108 for use in securely encrypting the encryption key using the new user secret to produce a new user encrypted key.

The receiver/transmitter 122 and processor 126 may be configured to receive the new user encrypted key from the service operator system 108 for use in updating the previous user encrypted key stored on the client device 102. Alternatively, the user of the client device 102 may directly receive the new user encrypted key from the service operator system 108.

The service operator system 108 includes one or more servers 130, which may be used for providing access security services that are used for securing data storage services used by the client device 102 or provided by the service provider system 106. The one or more servers 130 may also be used to enable the service operator system 108 to securely change and update a previous user encrypted key secured by encrypting the encryption key with the user secret. The encryption key is for use by the user's client device 102 to encrypt and decrypt data for storage, for example for securing data stored using an encryption key on data storage 104.

When the user would like to change their user secret, the user needs to use the back-up encrypted key that was generated based on their previous user secret. The user therefore is assumed to have access to the back-up encrypted key comprising the encryption key encrypted by the service operator secret. The server 130 includes a transmitter/receiver 132, a memory 134, and processor 136. The processor 136 is connected to the transmitter/receiver 132 and to the memory 134. The memory 134 can be for use in storing data and applications, and the processor 136 may execute the applications, and among other things, applications or processes for enabling the user to change the user secret previously used to secure the encryption key.

The transmitter/receiver 132 may receive encrypted back-up information directly from the user or the client device 102 or via the service provider system 103, which may act as a trusted third party entity. The encrypted back-up information includes the new user secret and the back-up encrypted key encrypted with the service operator secret. The processor 136 is configured to decrypt the encrypted back-up information using a corresponding service operator secret producing the encryption key and the new user secret. The processor 136 is configured to encrypt the encryption key with the new secret producing a new user encrypted key. The received back-up encrypted information, the decrypted new secret and the decrypted encryption key are removed such that the service operator system 108 only has access to the new user encrypted key. The new user encrypted key is stored in memory 134, or another data storage device or server, or in the user's account for use by the user in updating the previous user encrypted key with the new user encrypted key on the client device 102.

The transmitter 132 may also be configured to send a notification over the communication network or via a web portal that the previous user encrypted key has been updated with the new user encrypted key, and the processor 126 and transmitter 132 are configured for synchronising the client device 102 with the new user encrypted key. Alternatively or in addition to, the server 130 may be configured to send an update message to the client device 102 for updating the previous user encrypted key with the new user encrypted key, and transmit the new user encrypted key to the client device 102 on request.

Further examples of the invention are now described with reference to FIG. 1. As mentioned above, the client device 102 may include several applications for use in accessing the data storage 104 or even memory 112 on the client device 102. The user is an application user who accesses and uses the user secret to obtain secure access to user or application data stored on the data storage 104 or memory 112. The user secret may be used to secure an encryption key that is used to encrypt and decrypt user data or data generated by the application and stored on the secure data storage 104. The encryption key is backed-up by a key recovery service application that is operated by the service operator system 108, this allows the user to recover their access to the encrypted or secured user data should the user secret become mislaid or insecure. The applications on the client device 102 may have a client key recovery service integrated for communication to the service operator system 108 via the service provider system 106 as a third party or trusted third party entity.

The service operator system 108 may be an entity or system that operates an encryption key recovery service, allowing the user to recover their access to their data stored on data storage 104 should the user secret become forgotten or mislaid. The service provider system 106 is a third party entity or trusted third party entity or system that may provide one of the applications to the user for execution on the client device 102 for providing secure data storage services, which may store data on data storage 104. The service provider system 106 can also provide the application to the user of the client device 102 and the service operator key recovery service on behalf of the service operator system 108. It is also to be appreciated that the service operator system 108 and the service provider system 106 may be integrated into a single system that provides applications to users for execution on client devices 102 that implement secure data storage and provide a key recovery service. In such a case, the server operator secret would be provided by the single integrated system and is a secret (e.g. a public key) that may be used to encrypt data such that only the single integrated system has access to the corresponding secret (e.g. a private key) to decrypt data secured by the service operator secret.

In operation, an application executing on the client device 102 may initially establish means for securing the user data by securing an encryption key with a user secret (or user authentication credential or password) and a service operator secret (e.g. a service operator public key). The service operator secret may be provided by the service provider system 106 to the client device 102 when the user first subscribes or uses the application provided by the service provider system 106. Securing the encryption key is performed when the user of the application starts using the application. The application securely generates the encryption key. Once the encryption key has been generated, the user is may be requested or prompted for a user secret (a user authentication credential or password) for use by the application to secure the encryption key. The encryption key is used by the application to encrypt and decrypt data for storage on memory 112 or data storage 104 over a communication network.

Once the user enters a user secret, the application encrypts the encryption key using the user secret to produce a user encrypted key, which is stored to a local file on the client device 102. The application on the client device 102 then encrypts the encryption key using the service operator secret to produce a back-up encrypted key and stores the result to a local file on the client device 102. The application then securely deletes or destroys the generated encryption key, which may be a plain text encryption key, such that only two encrypted copies of the encryption key now exist on the client device 102. The first copy is the user encrypted key, which is the encryption key protected with the user secret, only the user has access to the user secret (e.g. a password). The second copy is the back-up encrypted key, which is the encryption key protected with the service operator public key, only the service operator system 108 has access to the back-up encrypted key when it is provided a copy of the back-up encrypted key.

The back-up encryption key is then encoded and reproduced to a physical item or device. For example, the back-up encrypted key may be converted into digital data and printed by the user. The digital data may comprise a bar code such as a two dimensional bar code in the form of a quick response (QR) code or any other suitable two dimensional code. The QR code will be referred to by way of example only as a suitable way to print digital information in a compact but machine readable form. Alternatively, the back-up encrypted key may be stored on a device such as a universal serial bus stick or a smart card type device. For example, the back-up encrypted key may be provided to the service provider system 106 for storing in a smart card. Special equipment such as a smart card reader is required to access the information stored on the smart card. The back-up encryption key may be stored in a machine readable format and stored externally to the client device 102.

After reproducing the back-up encrypted key on a physical item, storage, or device, the back-up encrypted key may be securely deleted or destroyed from the client device 102. This ensures that only one copy of the back-up encrypted key will exist and only be accessible to the user of the client device 102. The back-up encrypted key is now secured in a physical form external to the client device 102 and is only accessible by the user of the client device 102. The physical item or device of the back-up encrypted key is the only means by which the user secret (e.g. password) may be changed or reset. This may be when the user needs to change the user secret for security reasons (e.g. changing the user secret periodically) or has simply forgotten the user secret.

Once the encryption key has been secured into the user encrypted key, the user can begin using the application using the user secret to allow the application to gain access to the encryption key.

Each time the user uses the application on client device 102, the application requests the user to enter the user secret to allow the application to gain access to the encryption key used to encrypt and decrypt data. The user may enter the user secret using input unit 113. When the user enters the password correctly, the application can decrypt the user encrypted key from local storage e.g. memory 112 or other data storage on client device 102. The application then loads the encryption key to memory 112 of the client device 102 for use in the application context, which is to encrypt and decrypt user and/or application data for secure storage on data storage 104.

The application of the client device 102 may also use synchronization or file sharing mechanisms to pass the user encrypted key containing the encryption key to other devices 116. This may be performed using ad-hoc communication networks such as Bluetooth™ or any other communication network. The user encrypted key can be passed over insecure networks because the encryption is as strong as the user secret used to secure the user encrypted key. However, secure file sharing mechanisms can be used to provide additional security when transferring the user encrypted key. The advantage of sharing the user encrypted key with several devices 116 is that the user can use the same user secret on any other device 116 that supports encryption using the encryption key or the same or similar specific application functionality that can encrypt and decrypt data using the secured encryption key.

In the event that the user of the client device 102 needs to change the user secret or needs to regain access to the secure data due to losing the user secret and hence their access to the user encrypted key, a back-up mechanism is required otherwise the secure data is potentially insecure or inaccessible. If the user has forgotten the user secret that is used to gain access to the user encrypted key, the user may use the back-up encrypted key to change the user secret that was used to encrypt the locally stored encryption key. The back-up encrypted key is accessible to the user by the previously generated physical item or device (e.g. the printed QR code or a smart card), which contains the back-up encrypted key that comprises the encryption key encrypted with the service operator secret (e.g. the service operator public key).

The user of the client device 102 may request the user secret is changed by providing back-up information comprising the contents of the physical item or device (e.g. back-up encrypted data) and a new user secret to either the application on the client device 102 or to the service provider system 106. The service provider system 106 may act as an intermediate trusted third party that interfaces with the service operator system 108 over a communication network. Before sending the back-up information to the service operator system 108 or even the service provider system 106, the back-up information is secured to form back-up encrypted information.

The service operator secret may be used to encrypt the back-up information into back-up encrypted information. If the service provider system 106 is acting as the middleman, the service provider system 106 may be required to verify (for example using digital signature) that it has the authority to propagate the request for changing the user secret. If this is the case, service operator system 108 verifies the service provider system 104 before performing any further processing.

Once the service operator system 108 receives the back-up encrypted information and has verified either the user sending the back-up encrypted information and/or the service provider system 106, the service operator system 108 then proceeds to decode the back-up encrypted information. This can be performed using the service operator's reciprocal secret (e.g. a service operator private key) to retrieve the new user secret and the back-up encrypted key. The back-up encrypted key is also further decoded by decrypting the back-up encrypted key using the service operator's reciprocal secret.

The service operator system 108 then encrypts the encryption key using the new user secret to produce a new user encrypted key. The service operator system 108 then securely deletes or destroys the plain text encryption key such that the service operator system 108 only has access to the new user encrypted key. The service operator system 108 then prepares the file containing the new user encrypted key for use in updating/synchronising the application on client device 102 and/or other devices 116 that have synchronised with the client device 102 that also will require the new user encrypted key.

The new user encrypted key is updated/synchronised with client device 102 and application. As an example, the user may open the application on client device 102 such that the application, on start-up, notices that there is a new user encrypted key for updating the user secret via a key recovery service signalling. The application may cause client device 102 to communicate with the service provider system 106 or service operator system 108 to detect any new updates. The application may contact the service operator system 108 key recovery service back-end system and notices or detects that there is updated data available, which is new user encrypted key. The application then causes client device 102 to download the updated new user encrypted key. The application on the client device 102 then replaces the previous user encrypted key with the new user encrypted key (which was consumed using the forgotten password) in the local storage on client device 102.

The application may then request the user for the user secret (e.g. a password) and after entering the correct password the application on the client device 102 causes the processor 114 to decrypt the new user encrypted key comprising the encryption key to enable the client device 102 to encrypt and decrypt data. The application loads the encryption key to memory 112 on the client device 102 for use in the application context, e.g. for encrypting data when writing to data storage 104 for secure storage or decrypting data when reading secured data from data storage 104. On closing, the application may securely delete or destroy from memory 112 the plain text encryption key.

The above update procedure and requesting the new user secret may be repeated on the other client devices 116 that need to use the application or the functionality of the application with the new user encrypted key.

The advantages of the present invention provide for the back-up encrypted key comprising the encryption key encrypted with the service operator secret to be only produce on a physical item or device, such as a print out of a QR code or stored on a smart card, that is still protected. If this item or device is stolen or copied it cannot be used to compromise the user's encrypted data that was encrypted with the encryption key alone. Access to the user's encrypted data requires the service operator system 108 to carry out decryption of the back-up encrypted key that is encoded to the physical item or device. This can only be performed after positive user authentication has been achieved. That is when proper authentication and intent of the user is demonstrated.

In addition, the user has increased autonomy or control over the secure access to their encrypted data using the user encrypted key. This is because the service provider system 106 and the service operator system 108 do not have a copy of the unsecured encryption key or plain text encryption key. The service operator system 108 only has a copy of the unsecured or plain text encryption key during the brief period of time that the encryption key is being encrypted with a new user secret. This means that if the service provider system 106 or service operator system 108 is attacked the attacker will most likely be unable to retrieve the user's encryption key. All the data the attacker may receive is the user's data and the user's encrypted key in encrypted form. This benefits the user, because the user does not lose control over who can access their encrypted data, the user may be kept informed about receiving requests to access the data, and the user has the control to take decisive action towards means to access the data (the password and the physical item).

Referring to FIG. 1, another example of the present invention is described in which the user has a back-up encrypted key stored on a storage device such as a smart-card or universal serial bus stick or flash memory. The back-up encrypted key comprises an encryption key encrypted with a public key of a service operator system 108. In this example, the service operator system 108 provides an on-line storage platform for a secure on-line storage service. It is also the operator for a key recovery service. The service provider system 106 may be an Internet operator who subscribes to the secure on-line storage and the key recovery service from service operator system 108. Service provider system 106 may simply re-brand the secure storage services for their subscribers and their client devices, the users. A user of a client device 102 may be provided the secure on-line storage and key recovery service using an a client side application to access the secure on-line storage 104 over a range of various client devices, e.g. mobile phones, smart-phones, tablets, net-books, or even personal computers.

The encryption key may be a symmetric encryption key that is used to encrypt and decrypt data in the application. The user secret is a password that is used to encrypt and decrypt the encryption key in the application on the client device 102. Before data is written, this data is encrypted (using encryption key) at the application level before writing to the service provider's on-line data storage 104 (i.e. the service operators on-line data storage 104 provided to the service provider system 106). Before data is read, this data is decrypted (using encryption key) at the application level when read from on-line data storage 104.

When the user forgets their user secret (password) used by the online storage application on client device 102 then the user will need to gain access to the user encrypted key. To do so, the user uses their smart-card containing the back-up encrypted key to recover the key. The back-up encrypted key was provided to the user by the application as previously described. The user uses the back-up encrypted key to reset the password used to encrypt the encryption key. In order to do this, the user attends a service provider local branch office, which has access to a server 120 and hence the service provider system 106 enabling the user to securely reset the password. In this case, a clerk may manually authenticate the user by verifying the user's identity (e.g. personal identity card, driver's license, or passport etc) and the smart card. After positively identifying the user, the clerk may perform further checks to ensure the user should have a secure on-line storage and key recovery service using the service provider system 106.

After the user has been authenticated, the back-up encrypted key is uploaded from the user's smart card onto the service provider system 106. This can be performed with a smart-card reader connected to the service provider system 106. The service provider system 106 may then connect to the service operator system 106 using a web portal such that the service provider system 106 is securely authenticated and a secure connection is established between the service provider system 106 that connects with the service provider local office and the web portal of the service operator system 108.

The user may be prompted to enter a new password, which the user enters. As already described, the key recovery service of the service operator system 108 may receive the back-up encrypted data from the smart-card and the new password in a secure fashion from the service provider system 106. The service operator system 108 processes the back-up encrypted data and the new password to produce a new user encrypted key. As previously described, the service operator system 108 destroys the new user password and any plain text encryption key such that the servicer operator system 108 only has access to the new user encrypted key.

The service operator system 108 notifies the service provider system 106 that the password is now reset. This means that the user may execute the application on the client device 102 (e.g. a mobile phone) such that the client device 102 synchronises with the service operator system 108 and/or the service provider system 106 to retrieve the new user encrypted key. The new user encrypted key is used to replace the previous user encrypted key on the client device 102. The application on the client device 102 can execute, prompt the user for the password, and use the new encrypted key for accessing user's data on the on-line storage 104 as previously. In addition, any device running the application or applications with similar functionality as the application in relation to the user encrypted key may perform a similar synchronisation or update when the user uses these other devices 116 after the new user encrypted key is published.

It is to be appreciated that the authentication of the user may be performed automatically by having the user input biometric data (e.g. finger print, iris scan, voice recognition data, facial recognition etc). It is also to be appreciated that the user may instead have a smart-card reader connected to their client device 102, which securely connects with service provider system 106, such that the user does not need to attend a local branch.

In another example, the user has a print out of the back-up encrypted key represented as a two dimensional barcode such as a QR code. Again the user has forgotten their password to the on-line storage application stored and executed on client device 102. The client device 102 may include a camera e.g. a mobile phone with a camera (or a scanner). In this example, the user has printed a QR code representing the back-up encrypted key on a piece of paper. The back-up encrypted key comprises the encryption key encrypted with a service operator public key such that the service operator system 108 can decrypt the back-up encrypted key using a corresponding service operator private key. The user opens (runs) the secure on-line storage application on the client device 102 and requests the password to be reset. This may take the form of a reset password dialog box, in which there is a button “I forgot my password”, by selecting the button the user requests the password to be reset.

The application configures the client device 102 to change to the camera or scanner view and prompts the user to image the QR code that the user previously printed. The client device 102 then captures an image of the QR code. Image recognition software may then identify the image as a QR code, read and decode the QR code to produce the back-up encrypted key for use by the application and client device 102. The user may then be prompted by the application to enter a new password. This may take the form of an update password dialog box, in which there is a button “Update password”, by entering a new password and selecting the button the user requests the new password to be updated.

The application on the client device 102 packages the new password and the back-up encrypted key data into back-up information, which is encrypted again with the service operator public key. The encrypted package is then transmitted or sent to the service provider system 106. If the client device 102 is a mobile phone, the encrypted package may be sent to a special service number that deals with the password reset requests. On receipt of the encrypted package from the client device 102, the service provider system 106 performs an authentication check on the user and the client device 102. For example, if the client device 102 is a mobile phone, then the service provider system 106 may check the phone number of the mobile phone against active secure on-line storage and key recovery service subscriptions. After positively authenticating the user and/or the client device 102, the servicer provider system 106 signs the password change request and propagates the encrypted package in a message to the service operator system 108 for use in resetting the password. The password change request should not be signed until the user has been authenticated or positively authenticated.

On receipt of the message containing the encrypted package, the service operator system 108 performs an authentication check on the servicer provider system 106 that signed the message. When the service provider system 106 is validated, the service operator system 108 decrypts the entire package with the corresponding service operator private key to produce the new password and the back-up encrypted key. The service operator system 108 decrypts the back-up encrypted key using a corresponding service operator private key to produce the plain text encryption key. The service operator system 108 then encrypts the encryption key using the new password to produce a new user encrypted key. The service operator system 108 securely deletes or destroys the new password, the plain text encryption key, and the package such that the service operator system 108 only has access to the new user encrypted key. The service operator system 108 updates the encryption credentials on the on-line storage user's account for synchronising with the application on client device 102.

The application on the client device 102 (e.g. the user's mobile phone) is notified that password update is complete. The application on the client device 102 synchronises with the online storage user's account and causes the client device 102 to replace the previous user encrypted key with the new user encrypted key. The application then prompts the user to enter the password, which if entered correctly enables application to access the encryption key by decrypting the new user encrypted key. The user and the application on the client device 102 then gains access to the user encrypted data stored on the on-line data storage 104.

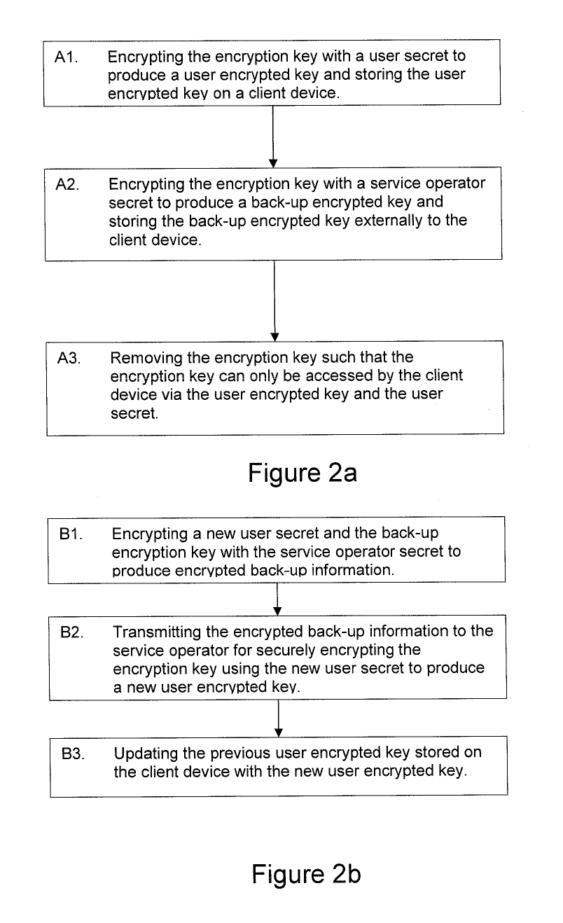

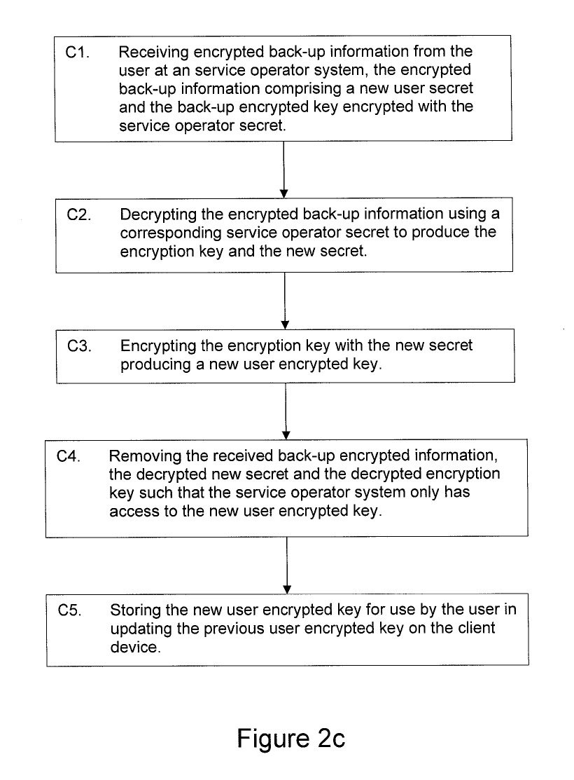

Referring to FIG. 2a, a flow diagram illustrating a process according to the invention for enabling a user to secure and back-up an encryption key for use by a client device 102 in encrypting and decrypting data. The process is described as follows:
A1. Encrypting the encryption key with a user secret to produce a user encrypted key and storing the user encrypted key on the client device;
A2. Encrypting the encryption key with a service operator secret to produce a back-up encrypted key and storing the back-up encrypted key externally to the client device 102;
A3: Removing the encryption key such that the encryption key can only be accessed by the client device 102 via the user encrypted key and the user secret.

Optionally, the step of storing the back-up encrypted key further comprises storing the back-up key in a machine readable format. Storing may include printing the back-up key in a machine readable format. Alternatively, the step of storing the back-up encrypted key further comprises storing the back-up encrypted key on a storage device. The service operator secret is a public encryption key and the service operator has a corresponding private encryption key. In addition, the method may further comprise synchronising the user encrypted key with a further client device for encrypting and decrypting data using the further client device. Further, the client device may transmit the user encrypted key to a remote server for retrieval by a further client device for encrypting and decrypting data using the further client device.

Referring to FIG. 2b, a flow diagram illustrating a process according to the invention for enabling a user to change a user secret previously used to secure an encryption key for use by a client device 102 in encrypting and decrypting data. The user has access to a back-up encrypted key comprising the encryption key encrypted by a service operator secret. The process further includes:
B1. Encrypting a new user secret and the back-up encryption key with the service operator secret to produce encrypted back-up information;
B2: Transmitting the encrypted back-up information to the service operator for securely encrypting the encryption key using the new user secret to produce a new user encrypted key;
B3: Updating the previous user encrypted key stored on the client device with the new user encrypted key when available from the service operator.

Optionally, the step of updating may include receiving the new user encrypted key from the service operator. This may include receiving a notification that the new user encryption key is available. This may further include downloading the new user encrypted key to the client device from the service operator or a service provider as a trusted third party. In addition, the process further includes authenticating the identity of the user prior to transmitting the encrypted back-up information to the service operator. Once the user has been positively authenticated then the encrypted back-up information is transmitted to the service operator. The process may further include synchronising the new user encrypted key with a further client device 102 for encrypting and decrypting data using the further client device. The service operator secret is a public encryption key and the service operator has a corresponding private encryption key for decrypting the back-up encrypted information.

Referring to FIG. 2c, a flow diagram illustrating a process according to the invention for enabling a service operator system or server 108 to update a previous user encrypted key secured by encrypting an encryption key with a user secret, the encryption key for use by a user's client device 102 to encrypt and decrypt data. The user has access to a back-up encrypted key comprising the encryption key encrypted by a service operator secret. The process further includes:
C1: Receiving encrypted back-up information from the user at the service operator system 108, the encrypted back-up information comprising a new user secret and the back-up encrypted key encrypted with the service operator secret;
C2: Decrypting the encrypted back-up information using a corresponding service operator secret to produce the encryption key and the new secret;
C3: Encrypting the encryption key with the new secret producing a new user encrypted key;
C4: Removing the received back-up encrypted information, the decrypted new secret and the decrypted encryption key such that the service operator system 108 only has access to the new user encrypted key;
C5: Storing the new user encrypted key for use by the user in updating the previous user encrypted key on the client device 102.

Optionally, the process may further include the steps of transmitting the new user encrypted key to the user or client device 102. Alternatively, it may include sending a notification that the previous user encrypted key has been updated with the new user encrypted key, and synchronising the client device 102 with the new user encrypted key on the service operator system 108. In addition, the process includes authenticating the identity of the user prior to receiving the encrypted back-up information. Once the user has been positively authenticated, the encrypted back-up information may then be received. Alternatively or in addition to these steps, the process may further include positively authenticating the identity of the user prior to transmitting the new user encrypted key. Optionally, the service operator secret is a public encryption key and the corresponding service operator secret is a private encryption key for decrypting the back-up encrypted information and back-up encrypted key.

The client devices, service provider apparatus, systems and servers, service operator apparatus systems and servers, and computing systems as described herein each may be configured to perform the method or processes for enabling a user to secure an encryption key with a user secret, secure a back-up of the encryption key using a service operator's secret, and subsequently change the user secret using the back-up encryption key. The processors of such systems are configured to execute computer program instructions based on the methods and processes described herein, such instructions being contained in a computer-readable medium, such as memory. The computer program instructions may be read into memory from another computer-readable medium or from another device via a communication interface. The instructions contained in memory may cause the processor of a client device, service provider systems and servers, service operator systems and servers, or other such computing systems to perform processes or methods as described herein. Alternatively or in addition to, hardwired circuitry may be used in place of, or in combination with, the computer program instructions to implement processes and methods consistent with the present invention. Examples of hardware circuitry may include, but are not limited to, semiconductor chips, integrated circuits, field programmable gate arrays, application-specific integrated circuits, electronically programmable integrated circuits and the like. Thus, the present invention is not limited to any specific combination of hardware circuitry and/or software.

In further examples there may be provided a computer program including computer program code means or program instructions for enabling a user to secure and back-up an encryption key for use by a client device 102 in encrypting and decrypting data, the instructions, which when executed on a processor or other circuitry, performs the steps of encrypting the encryption key with a user secret to produce a user encrypted key and storing the user encrypted key on the client device, encrypting the encryption key with a service operator secret to produce a back-up encrypted key and storing the back-up encrypted key either internally or preferably externally to the client device 102, and removing the encryption key such that the encryption key can only be accessed by the client device 102 via the user encrypted key and the user secret.

Additionally, as another example there may be provided a computer program including computer program code means or program instructions for enabling a user to change a user secret previously used to secure an encryption key for use by a client device in encrypting and decrypting data, where the user has access to a back-up encrypted key comprising the encryption key encrypted by a service operator secret, the instructions, which when executed on a processor or other circuitry of a client device or service provider device or trusted third party device, performs the steps of encrypting a new user secret and the back-up encryption key with the service operator secret to produce encrypted back-up information, transmitting the encrypted back-up information to the service operator for securely encrypting the encryption key using the new user secret to produce a new user encrypted key, receiving notification to retrieve the new user encrypted key from the service operator for use in updating the previous user encrypted key stored on the client device.

In addition, as a further example, there may be provided a computer program including computer program code means or program instructions for enabling a service operator server, or one or more servers, or a cluster of servers, to update a previous user encrypted key secured by encrypting an encryption key with a user secret, the encryption key for use by a user's client device to encrypt and decrypt data, and the user having access to a back-up encrypted key comprising the encryption key encrypted by a service operator secret, the instructions, which when executed on a processor or other circuitry of a client device, performs the steps of receiving encrypted back-up information from the user at the server, the encrypted back-up information comprising a new user secret and the back-up encrypted key encrypted with the service operator secret, decrypting the encrypted back-up information using a corresponding service operator secret to produce the encryption key and the new secret, encrypting the encryption key with the new secret producing a new user encrypted key, removing the received back-up encrypted information, the decrypted new secret and the decrypted encryption key such that the server only has access to the new user encrypted key, storing the new user encrypted key for use by the user in updating the previous user encrypted key on the client device.

Although the service provider and service operator apparatus, systems or servers have been described, by way of example only, in some of the above-mentioned examples as separate entities, systems, or servers, it will be appreciated by the person of skill in the art that the servicer provider and service operator apparatus, systems or servers can be the same entity or organisation and the corresponding apparatus, systems, methods, and processes as described may be implemented together on the same apparatus or servers.

It will be appreciated by the person of skill in the art that various modifications may be made to the above described examples or embodiments and/or one or more features of the described examples or embodiments may be combined without departing from the scope of the present invention.

1. A method of enabling a user to secure and back-up an encryption key for use by a client device in encrypting and decrypting data, the method comprising:
receiving a user secret from the user;
encrypting the encryption key with the user secret to produce a user encrypted key and storing the user encrypted key on the client device;
encrypting the encryption key with a service operator secret to produce a back-up encrypted key and storing the back-up encrypted key; and
removing the encryption key such that the encryption key can only be accessed by the client device via the user encrypted key and the user secret.

2. A method according to claim 1, wherein the client device performs encryption or decryption of data by:
prompting the user for the user secret;
decrypting the user encrypted key with the user secret to produce the encryption key;
encrypting or decrypting data using the produced encryption key; and
removing the produced encryption key;

3. A method according to claim 1, wherein the step of storing the back-up encrypted key further comprises storing the back-up encrypted key in a machine readable format.

4. A method according to claim 1, wherein the step of storing the back-up encrypted key further comprises storing the back-up encrypted key externally to the client device in a machine readable format.

5. A method according to claim 1, wherein the user secret includes at least one form of secret information from the group of:
a user password;
a user passcode;
biometric data;
a secret gesture;
a biometric fingerprint;
facial recognition data;
voice recognition data;
information or data of the user to secure the encryption key; and
information or data selected by the user to secure the encryption key.

6. A method according to claim 1, wherein the step of receiving the user secret further comprises the steps of:
inputting a plaintext user secret; and
encrypting the plaintext user secret to produce the user secret.

7. A method according to claim 1, wherein the client device is unable to decrypt the back-up encrypted key using the service operator secret.

8. A method according to claim 7, wherein the service operator secret is a public encryption key and the service operator has a corresponding private encryption key.

9. A method according to claim 1, further comprising synchronising the user encrypted key with a further client device for encrypting and decrypting data using the further client device.

10. A method for enabling a user to change a user secret previously used to secure an encryption key for use by a client device in encrypting and decrypting data, wherein the user has access to a back-up encrypted key comprising the encryption key encrypted by a service operator secret, the method comprising the steps of:
receiving the back-up encrypted key and a new user secret;
encrypting the new user secret and the back-up encrypted key with the service operator secret to produce encrypted back-up information;
transmitting the encrypted back-up information to the service operator for securely encrypting the encryption key using the new user secret to produce a new user encrypted key, wherein the new user encrypted key is used for updating the previous user encrypted key stored on the client device.

11. A method according to claim 10 further comprising the step of receiving the new user encrypted key for updating the previous user encrypted key stored on the client device.

12. A method according to claim 10, wherein the back-up encrypted key is stored externally to the client device in a machine readable format.

13. A method according to claim 10, wherein the step of receiving the new user encrypted key further comprises retrieving from the service operator the new user encrypted key for use in updating the previous user encrypted key stored on the client device.

14. A method according to claim 10, wherein:
the step of receiving further comprises the client device or a third party device performing the step of receiving the back-up encrypted key and the new user secret;
the step of encrypting further comprises the client device or the third party device encrypting the new user secret and the back-up encryption key with the service operator secret to produce encrypted back-up information;
the step of transmitting further comprises the client device or the third party device transmitting the encrypted back-up information to the service operator.

15. A method according to claim 14, further comprising authenticating the identity of the user prior to transmitting the encrypted back-up information to the service operator.

16. A method according to claim 14, wherein the step of transmitting the encrypted back-up information to the service operator further comprises transmitting the encrypted back-up information to the service operator via a third party.

17. A method according to claim 16, further comprising transmitting authentication information from the client device for use by the third party in authenticating the user prior to the third party transmitting the back-up encrypted information to the service operator.

18. A method according to claim 10, wherein the service operator secret is a public encryption key and the service operator has a corresponding private encryption key for decrypting the back-up encrypted information.

19. A method for enabling a server to update a previous user encrypted key secured by encrypting an encryption key with a user secret, the encryption key for use by a client device of the user to encrypt and decrypt data, and the user having access to a back-up encrypted key comprising the encryption key encrypted by a service operator secret, the method comprising the steps of:
receiving encrypted back-up information from the user at the server, the encrypted back-up information comprising a new user secret and the back-up encrypted key encrypted with the service operator secret;
decrypting the encrypted back-up information using a corresponding service operator secret to produce the encryption key and the new user secret;
encrypting the encryption key with the new user secret producing a new user encrypted key;
removing the received back-up encrypted information, the decrypted new user secret and the decrypted encryption key such that the server only has access to the new user encrypted key;
storing the new user encrypted key for use by the user in updating the previous user encrypted key on the client device.

20. A method according to claim 19, further comprising the step of synchronising the client device with the new user encrypted key on the server.

21. A method according to claim 19, wherein the service operator secret is a public encryption key and the corresponding service operator secret is a private encryption key for decrypting the back-up encrypted information and back-up encrypted key.

22. An apparatus for use in enabling a user to secure and back-up an encryption key for use by a client device of the user in encrypting and decrypting data, the apparatus comprising:
a receiver, a transmitter, a memory unit, and a processor, the processor being connected to the receiver, to the transmitter, and to the memory unit, wherein:
the processor is configured to:
receive a user secret;
encrypt the encryption key with the user secret to produce a user encrypted key and store the user encrypted key on the memory unit;
encrypt the encryption key with a service operator secret to produce a back-up encrypted key and store the back-up encrypted key; and
remove the encryption key such that the encryption key can only be accessed by the client device via the user encrypted key and the user secret.

23. An apparatus according to claim 22, wherein the processor and transmitter are further configured to synchronise the new user encrypted key with a further client device for encrypting and decrypting data using the further client device.

24. An apparatus for use in enabling a user to change a user secret previously used to secure an encryption key for use by a client device in encrypting and decrypting data, wherein the user has access to a back-up encrypted key comprising the encryption key encrypted by a service operator secret, the apparatus comprising:
a receiver, a transmitter, a memory unit, and processor, the processor being connected to the receiver, to the transmitter, and to the memory unit, wherein:
the processor is configured to:
receive a new user secret and the back-up encrypted key;
encrypt the new user secret and the back-up encryption key with the service operator secret to produce encrypted back-up information; and
the transmitter is configured to transmit the encrypted back-up information to the service operator for securely encrypting the encryption key using the new user secret to produce a new user encrypted key for use in updating the previous user encrypted key stored on the client device.

25. An apparatus according to claim 24, wherein the processor, transmitter, and receiver are further configured to synchronise the new user encrypted key with the client device for encrypting and decrypting data.

26. An apparatus for use in enabling a service operator to update a previous user encrypted key secured by encrypting an encryption key with a user secret, the encryption key for use by a user's client device to encrypt and decrypt data, wherein the user has access to a back-up encrypted key comprising the encryption key encrypted by a service operator secret, the apparatus comprising:
a receiver, a transmitter, a memory unit, and processor, the processor being connected to the receiver, to the transmitter, and to the memory unit wherein:
the receiver is configured for receiving encrypted back-up information from the user, the encrypted back-up information comprising a new user secret and the back-up encrypted key encrypted with the service operator secret; and
the processor is configured to:
decrypt the encrypted back-up information using a corresponding service operator secret producing the encryption key and the new user secret;
encrypt the encryption key with the new user secret producing a new user encrypted key;
remove the received back-up encrypted information, the decrypted new user secret and the decrypted encryption key such that the service operator only has access to the new user encrypted key; and
store the new user encrypted key for use by the user in updating the previous user encrypted key on the client device.

27. An apparatus according to claim 26, wherein the transmitter is configured to send the new user encrypted key to the client device.

28. A computer readable medium including computer program instructions stored thereon which, when executed on one or more processors, performs the method steps of claim 1.

29. A computer readable medium including computer program instructions stored thereon which, when executed on one or more processors, performs the method steps of claim 10.

30. A computer readable medium including computer program instructions stored thereon, which when executed on one or more processors, performs the method steps of claim 19.
